(19) United States
(12) Patent Application Publication
(10) Pub. No.: US 2009/0303229 A1
(43) Pub. Date: Dec. 10, 2009

(54) ERGONOMIC LIGHTING SYSTEM

(75) Inventors: Cornelis Wilhelmus Kwisthout, Eindhoven (NL); Willem Franciscus Johanne Hoogenstraaten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,526

(22) PCT Filed: Dec. 18, 2007
(86) PCT No.: PCT/IB2007/055193

§ 371 Date: Jun. 17, 2009

(30) Foreign Application Priority Data
Dec. 21, 2006 (EP) 06126742.3

(51) Int. Cl. G09G 5/00

(52) U.S. Cl. 345/214

(57) ABSTRACT

This invention relates to an ergonomic lighting system for a display device including an image display region. An image analyzer determines the color information of a video signal to be displayed in the image display region. Light emitting means is disposed such that it peripherally surrounds the image display region for emitting an ergonomic light towards a viewing region of the image display region. A control unit controls the light source by adapting, in response to the determined color information, the light emitted by the light emitting means to the determined color information. The controlling is performed in accordance to pre-defined selection rules linking the color information of the video signal to be displayed to the property of the emitted ergonomic light.

### FIELD OF THE INVENTION

The present invention relates to an ergonomic lighting system for a display device and a method of operating the lighting system, and to a display device comprising such ergonomic lighting system.

### BACKGROUND OF THE INVENTION

Working conditions is one of the issues that are being discussed today. One group of people where this has been in the discussion is computer users. A large part of the people, especially in the western world, does not only spend a large part of the daytime in front of the computer, but also at home. This can increase the tiredness in the eyes which often leads to headaches.

With better computer monitors or developing filter to be placed in front of the computer monitors, this issue has only partly been solved. Still, many computer users suffer from tiredness when sitting in front of the computers many hours a day. There is therefore a need for a further improvement for solving this problem.

### BRIEF DESCRIPTION OF THE INVENTION

The object of the present invention is to improve the current methods in providing relaxed working condition for computer user.

According to one aspect the present invention relates to an ergonomic lighting system for a display device including an image display region, comprising:

an image analyzer for determining color information of a video signal to be displayed in the image display region,

a light emitting means disposed such that it peripherally surrounds the image display region and adapted for emitting static ergonomic lights towards a viewing region of the image display region, and

a control unit for adapting, in response to the determined color information, the light emitted by the light emitting means to the determined color information, wherein the adaptation is performed in accordance to pre-defined selection rules linking the color information of the video signal to be displayed to the static ergonomic lights to be emitted.

Thus, by emitting such ergonomic light towards the viewer sitting in front of the display region the working condition for the computer user will be significantly improved. A further advantage of the present invention is that the property, the intensity and/or the color of the ergonomic light, is adapted to the color/brightness of the image on the display region. This improves the working condition for the computer user further. It is namely so that an opposite effect is reached if such an adaptation is not done, e.g. if the running application on the display region is relatively dark and there is a very bright ergonomic light around the display region. Such a relative bright ergonomic light around the display region could however be suitable if the running application (the overall color on the display region) is different, e.g. blue or white. With the term static light is meant a light having a fixed brightness, or a fixed color, or a fixed brightness and color.

In one embodiment, the light emitting means comprises; a light guide that peripherally surrounds the display region; at least one light source adapted to emit light of at least one wavelength into the light guide such that the light becomes conducted within the light guide; and an out-coupling structure adapted to interact with the light within the light guide and thus extract the light out of the light guide towards the viewing region.

Thus, by implementing such an illuminating “frame system” it is possible to generate a homogeneous light source that emits light of one or more wavelengths, and where the light intensity is substantially constant which makes the surrounding of the display device more relaxing for the eyes.

In one embodiment, the light emitting means comprises a light emitting surface placed behind the image display region.

This light emitting surface may e.g. be the wall behind the image display region.

According to another aspect, the present invention relates to a display device comprising an ergonomic lighting system as disclosed here above.

In one embodiment, the display device is a computer device and the display region is a computer monitor.

According to still another aspect, the present invention relates to a method of operating an ergonomic lighting system arranged on a display device including an image display region, the ergonomic lighting system comprising a light emitting means disposed such that it peripherally surrounds the image display region and adapted for emitting static ergonomic lights towards a viewing region of the image display region, the method comprising:

determining color information of an incoming video signal to be displayed in the image display region, and

adapting, in response to the determined color information, the light emitted by the light emitting means to the determined color information, wherein the adaptation is performed in accordance to pre-defined selection rules linking the color information of the video signal to be displayed to the static ergonomic lights to be emitted.

In one embodiment, the pre-defined selection rules comprise a link between the brightness value in the incoming video signal and a brightness value of the static ergonomic light to be emitted.

Thus, the brightness of the ergonomic light can be adapted to the brightness of the image/content in the display region.

In one embodiment, the pre-defined selection rules comprise a link between the color in the incoming video signal and a color of the static ergonomic light to be emitted.

Thus, the color of the ergonomic light can be adapted to the color of the image/content (the dominant color) in the display region and can be one or more colors. This can be realized by using the total monitor content as a source for deriving the overall color of the content using the available detectors for active, e.g. a peak detector or an average color detector. This derived overall color may then be converted to the wanted color e.g. by using a matrix that converts the primaries and natural white point of the lighting system to the color triangle with the emitted color as ‘white point’ and the three light primaries (e.g. small shifts to red, green and blue).

In one embodiment, the pre-defined selection rules comprise a link between the brightness and the color in the incoming video signal and a brightness and a color of the static ergonomic light to be emitted.

In one embodiment, the color of the emitted ergonomic light is a static color selected from:

cyan,

a bluish color,

a yellowish color,

and the like.

According to yet another aspect, the present invention computer program product for instructing a processing unit to execute the above mentioned method steps when the product is run on a computer.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows an ergonomic lighting system for a display device including an image display region according to the present invention, and

FIG. 2 shows a flowchart of a method according to the present invention.

### DESCRIPTION OF EMBODIMENTS

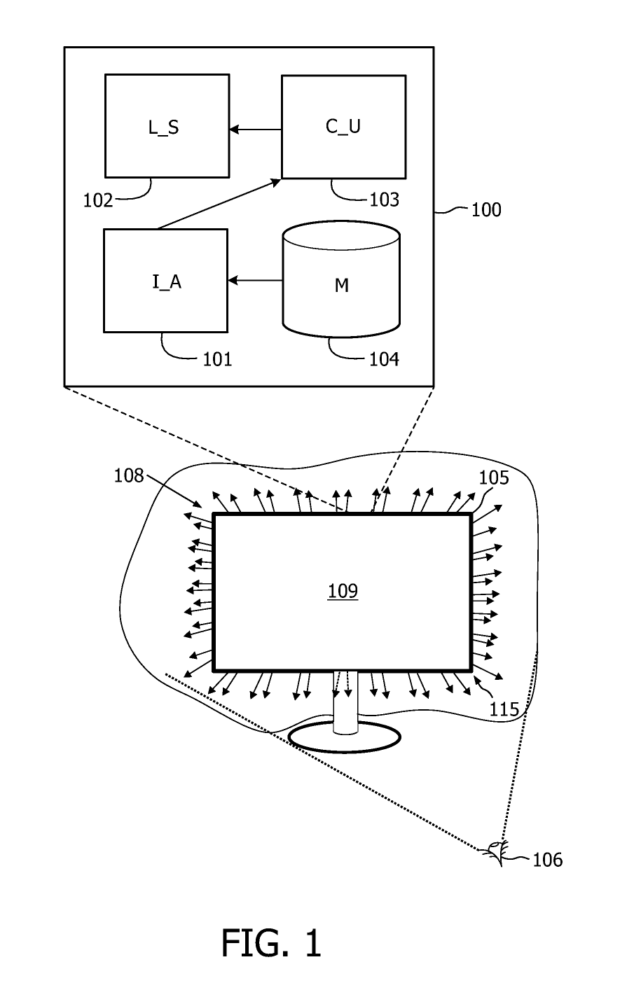

FIG. 1 shows ergonomic lighting system 100 for a display device 108 including an image display region 109 according to the present invention. The ergonomic lighting system 100 comprises an image analyzer 101 for determining color information of a video signal to be displayed in the image display region, a light emitting means (L_S) 102 disposed arranged such that it peripherally surrounds the image display region 109 and is adapted to emit a static ergonomic light towards a viewing region of the image display region, and a control unit (C_U) 103 adapted to adapt, in response to the determined color information, the light emitted by the light emitting means (L_S) 102 to the color information determined from the incoming video signal. The controlling is performed in accordance to pre-defined selection rules stored at a memory (M) 104, where the selection rules link the color information of the video signal to be displayed to the property of the emitted ergonomic light.

Assuming the default color to be emitted by the emitting means (L_S) 102 is a cyan or blue like color then it might be preferred to define a small triangle around this color so that e.g. the top corner of the triangle is shifted a little bit from the default color emitted by the emitting means (L_S) 102 to the green EBU (European Broadcasting Union_EBU) primary. The bottom left corner of the triangle might be shifted a little bit from the default color emitted by the emitting means (L_S) 102 to the blue EBU primary, and the bottom right corner might be shifted a bit more from the default color than the others towards the red EBU primary.

Once the triangle is defined which e.g. lies within the EBU triangle (it may as well span the same color range as the EBU triangle) the “mapping” may be a linear mapping from the big EBU triangle to the small triangle. Thus, in this case the selection rules stored at a memory (M) 104 may be a function that performs this mapping, e.g. a linear function that performs a linear mapping. Accordingly, first the overall color of the monitor content is derived (peak, average etc.) and subsequently this color (which fits in the EBU triangle) is converted to fit in the smaller triangle. This conversion could also be derived from a lookup table that does a similar thing, e.g. colors in the left bottom corner of the EBU triangle are mapped on the left bottom corner of the small triangle.

In one embodiment, the selection rule is in a form of a table that links the detected color information to color information of the light to be emitted by the light emitting means 102. This means that e.g. the brightness value (the Y value) of e.g. the overall content in the incoming video signal is associated (or linked) with a preferred brightness of the ergonomic light. In the same way, the color, such as in the chrominance color plane, or the RGB color plane, is associated with a preferred color to be of the ergonomic light. In the same way, the color and the brightness of the incoming video signal is associated with a preferred brightness and color of the ergonomic light. The generation of such a table or set of rules is preferably done manually be experts based on experiments or experience. These experts could be eye doctors. Thus, when a particular color is displayed on the display region (the computer monitor), the most convenient color is emitted. By the term convenient is meant the color that causes minimum tiredness in the eyes. The same applies for the intensity, and the combination of intensity and colors. Thus, if e.g. the displayed color is blue, it might be preferred to emit a bluish color of the same intensity, and if the color in the displayed image is black, it might be preferred to emit dark bluish color or purple color. As an example, it might be relevant, considering the color component in the image to be displayed not to have to much contrast between the color on the display region 109 and the color of the ergonomic light, e.g. if the background image on the display region is black it might be preferred to link a color component that is relatively dark, e.g. a blue or bluish color, instead of using e.g. a white color (similar as placing a computer monitor in front of a window during the day). Also, it might be preferred to have similarities between the intensity of the image displayed on the display region 109 and the intensity of the ergonomic light. The determination could just as well be done automatically by e.g. monitoring the reaction of the lens to different display colors and/or display intensities.

Also, the selection rule might be adapted to an individual user which is e.g. sensitive towards special colors or towards intensity.

In one embodiment, the emitted light from the light emitting means 102 when the image content of the display region 109 changes is adapted over some period of time, which can be pre-defined. This is to prevent the ergonomic light does not change suddenly, although the user of the display device, e.g. a computer, changes the office application (e.g. switching from word to excel), but instead adapts slowly to the new image content. Thus, if the image content changes from where the white color is the dominant color in the background (e.g. a word document) over to a black background, the adaptation would occur slowly, e.g. from light bluish color to dark bluish color. Preferably, this adaptation time is optimized based on the reaction of the eyes so that the user will almost not notice the adaptation.

In one embodiment, the light emitting means 102 comprises a at least one light source, e.g. LED that can emit light of at least one wavelength and a thin light guide 105 (e.g. of few millimeters) made of e.g. transparent material that peripherally surrounds the display region 109, and light source such as Light Emitting Diodes (LED's) that emit light of at least one wavelength into the light guide such that the light becomes conducted within the light guide. In this embodiment, the light guide 105 is further provided with an out-coupling structure (e.g. white dots or grooves) adapted to interact with the light within the light guide and thus extract the light out of the light guide towards the viewing region, i.e. towards the user 106 sitting in front of the display. Other kind of frame systems or the like are of course possible. In another embodiment, the light emitting means is a surface placed behind the display region 109, e.g. a transportable surface, or the wall behind the display region 109.

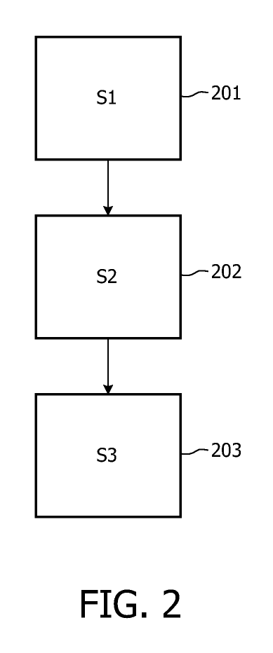

FIG. 2 shows a flowchart of a method according to the present invention method of operating an ergonomic lighting system arranged on a display device including an image display region, the ergonomic lighting system comprising light emitting means disposed such that it peripherally surrounds the image display region for emitting a static ergonomic light towards a viewing region of the image display region.

The color information of an incoming video signal to be displayed in the image display region is determined (S1) 201 color information. The color information may include the color to be displayed in the image display region, e.g. the RGB color components or the UV chrominance component, the intensity of the image to be displayed (the Y value from the YUV domain), or the combination of the color and the intensity components.

The determined color information is now used as a control parameter for controlling (S2) 202 the light emitted by the light emitting means, wherein the controlling is performed in accordance to said pre-defined selection rules (S3) 203 linking the color information of the video signal to be displayed to the property of the emitted ergonomic light.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the spirit and scope of this disclosure. Further, in this context, and for the purposes of brevity and clarity, detailed descriptions of well-known apparatuses, circuits and methodologies have been omitted so as to avoid unnecessary detail and possible confusion.

Reference signs are included in the claims, however the inclusion of the reference signs is only for clarity reasons and should not be construed as limiting the scope of the claims.

1. An ergonomic lighting system (100) for a display device (108) including an image display region (109), comprising:
an image analyzer (101) for determining color information of a video signal to be displayed in the image display region,
a light emitting means (102) disposed such that it peripherally surrounds the image display region (109) and adapted for emitting static ergonomic lights towards a viewing region of the image display region, and
a control unit (103) for adapting (202), in response to the determined color information, the light emitted by the light emitting means to the determined color information,
wherein the adaptation is performed in accordance to pre-defined selection rules linking the color information of the video signal to be displayed to the static ergonomic lights to be emitted.

2. An ergonomic lighting system according to claim 1, wherein the light emitting means (102) comprises; a light guide (105) that peripherally surrounds the display region (109); at least one light source adapted to emit light of at least one wavelength into the light guide such that the light becomes conducted within the light guide; and an out-coupling structure adapted to interact with the light within the light guide and thus extract the light out of the light guide towards the viewing region.

3. An ergonomic lighting system according to claim 1, wherein the light emitting means (102) comprises a light emitting surface placed behind the image display region (109).

4. A display device (108) comprising an ergonomic lighting system according to claim 1.

5. A display device according to claim 4, wherein the display device is a computer device and the display region is a computer monitor.

6. A method of operating an ergonomic lighting system arranged on a display device including an image display region, the ergonomic lighting system comprising a light emitting means disposed such that it peripherally surrounds the image display region and adapted for emitting static ergonomic lights towards a viewing region of the image display region, the method comprising:
determining (201) color information of an incoming video signal to be displayed in the image display region, and
adapting (202), in response to the determined color information, the light emitted by the light emitting means to the determined color information,
wherein the adaptation is performed in accordance to pre-defined selection rules linking the color information of the video signal to be displayed to the static ergonomic lights to be emitted.

7. A method according to claim 6, wherein the pre-defined selection rules comprise a link between the brightness value in the incoming video signal and a brightness value of the static ergonomic light to be emitted.

8. A method according to claim 6, wherein the pre-defined selection rules comprise a link between the color in the incoming video signal and a color of the static ergonomic light to be emitted.

9. A method according to claim 6, wherein the pre-defined selection rules comprise a link between the brightness and the color in the incoming video signal and a brightness and a color of the static ergonomic light to be emitted.

10. A method according to claim 8, wherein color of the at least first and the second static lights is selected from:
cyan,
a bluish color,
a yellowish color,
and the like.

11. A computer program product for instructing a processing unit to execute the method step of claim 6 when the product is run on a computer.
